(19) United States
(12) Patent Application Publication
(10) Pub. No.: US 2016/0043556 A1
(43) Pub. Date: Feb. 11, 2016

(54) POWER MANAGEMENT CONCEPT IN DC DISTRIBUTED SYSTEMS

(71) Applicant: Arda Power Inc., Oakville (CA)

(72) Inventor: Luis Zubieta, Oakville (CA)

(21) Appl. No.: 14/858,856

(22) Filed: Sep. 18, 2015

Related U.S. Application Data
(63) Continuation-in-part of application No. 13/828,290, filed on Mar. 14, 2013.
(60) Provisional application No. 62/182,788, filed on Jun. 22, 2015.

(51) Int. Cl. H02J 3/38; H02M 3/04; H02J 1/00

(52) U.S. Cl. CPC H02J 3/382; H02J 1/00; H02J 3/383; H02J 3/386; H02J 3/387; H02M 3/04

(57) ABSTRACT

A system and method to interconnect several conventional or alternative power generators, loads, and/or energy storage elements physically separated from each other in a DC distribution system. The method includes the steps of providing a common DC bus to interconnect all of the elements in the DC distributed system using power converters. A first group of one or more of the elements (main element) is used to automatically maintain the voltage of the DC link following a set a set point to provide for the load matching. The average DC link voltage (set point) maintained by the main element is intentionally changed in order to indicate all of the other elements connected to the DC bus how they need to modify their power generation or consumption.

### CROSS-REFERENCE TO CO-PENDING APPLICATIONS

This application is a continuation-in-part of U.S. patent application Ser. No. 13/828,290 filed Mar. 14, 2013 and claims priority on U.S. Provisional Patent Application Ser. No. 62/182,788, filed Jun. 22, 2015.

### BACKGROUND OF THE INVENTION

1. Field of the Invention

The present invention is a method and system to interconnect several conventional or alternative power generators, loads, and/or energy storage elements physically separated from each other in a DC distribution system.

2. Prior Art

Distributed DC systems are used to exchange power among multiple sources (mainly renewable energy resources), loads, and energy storage elements by connecting those elements to a common DC bus using power converters or direct connection in a concept generally called DC microgid. DC microgrids could be as simple as solar+storage installation or as complex as multi MW systems with many types of different generators, multiple ratings and varieties of loads, several different types of energy storage elements and multiple inverters connected or separated from the grid.

The reliability of a DC microgrid depends on the control of the DC bus voltage within specified limits, which depends on balancing the power production with the power consumption. Because renewable energy sources are intermittent in nature and loads can suddenly change, fast response from power converters and capacitive energy storage in the DC bus provide the means to instantaneously maintain the DC bus. Methods to control the DC bus voltage are well known and developed where one or multiple elements connected to the DC bus change their power quickly as the DC bus voltage drifts from the set point to balance the total power in the bus and maintain the DC bus voltage within acceptable limits.

In addition to maintaining the DC bus voltage, in most cases it is necessary to execute additional functions in the DC distributed system such as an energy management strategy to maintain the energy storage elements within their charge limits or grid ancillary functions (load shifting, grid support, etc). Frequently, these additional functions are executed by the inverters connected to the AC utility grid but they are still needed when operated independent from the AC utility or in systems with low power interconnection to the AC utility. These additional functions (SECONDARY FUNCTION) demand additional coordination and communication amongst the different components connected to the DC bus.

Wired and wireless communication means are commonly used to achieve power and energy balance between the different elements at the expense of extra cost and low flexibility. Intentionally changing the average value of the DC bus voltage has been used as a mean of communication amongst elements in a DC distributed system. The present implementations and their limitations can be divided in two groups:
Some of them use a single element or small group of elements to maintain the bus and intentionally change its average value so that discreet voltage levels in the DC bus indicate changes in operating mode to the other elements connected to the bus. The new operating mode shifts the responsibility to maintain the DC bus voltage to a different element and forces a quick reaction of all the elements in order to maintain operation. Precise voltage measurements for all the components connected to the bus are fundamental to the successful operation of the system. Also, aging and tolerances in sensors degrade highly the performance of the DC distributed system.
In other cases, DC bus voltage changes, resulting from changes in the power balance, trigger reactions in multiple or all of the elements to balance the power and maintain the DC bus within a specified range of voltages. In this case, the system stability is difficult to achieve and oscillations are common. Furthermore, for these concepts it is not possible to incorporate a second function, such as energy management, on top of the power balancing.

In general, all of these proposals require major re-engineering when additional resources or loads are added to the DC microgrid or when a new installation with different ratings is implemented.

### SUMMARY OF THE INVENTION

Use of DC-Link Voltage for Communication among Components in a DC Distributed Systems for Energy Management

During modeling and analysis of the distributed PV system, it was conceived a method to achieve power balance and energy management automatically using only the DC bus voltage as mean of communication. The proposed method uses one element on the microgrid as the brain of the microgrid operation (MAIN ELEMENT). In most cases, this element will be one or multiple energy storage devices provided with fast responding power converters. However, in other cases, this element could be an inverter connected to the utility grid.

Because the DC-link is connected to each of the power converters so they can feed their processed power, all of them will have access to a DC-link voltage measurement (normally this voltage measurement is part of the power converters as it is needed for control and protection). The DC-link voltage is maintained in a classical way by the MAIN ELEMENT executing a control algorithm. However, the MAIN ELEMENT collects information and executes an algorithm to coordinate the SECONDARY FUNCTION. The output of this algorithm is a change in DC voltage set point such that the average DC voltage is slightly drifted from the nominal value. Because the MAIN ELEMENT has the capability to maintain the DC bus voltage, only a modification in its software is needed to intentionally vary the average DC-link voltage depending on the SECONDARY FUNCTION.

The range in variable average DC-link voltage should be limited such that the maximum and minimum voltages Vₙₒₘ +/−ΔVmax do not result in any degradation in performance or incorrect operation of any of the components and the time constant of the controller should be slow enough to allow for the distributed converters to react to the change in DC-link voltage.

All the elements connected to the DC bus except the MAIN ELEMENT are measuring the average DC link voltage and reacting to it by changing their output power such that the full effect is the fulfillment of the SECONDARY FUNCTION. All these elements are not aware of the requirements, limitations, or constrains of the SECONDARY FUNCTION but simply follow the direction from the MAIN ELEMENT that has been communicated using the average DC link voltage. Note than only the MAIN ELEMENT is responsible for the fast regulation of the DC bus voltage while all the other elements respond to the much slower average voltage. This increases the stability of the system and enables calibration

It was also realized that the algorithm to set the average DC-link voltage can be any relation that may include linear, quadratic, integral, or derivate terms amongst others. Furthermore, these terms may depend on state of charge, energy, power, current, temperature or any other variable that can be regulated based on average power. The variable to be used depends on the specific constrains for each application. The average DC bus voltage can be continuously changed by the MAIN ELEMENT within a small range to produce smooth and sequenced responses from all the other components in the DC distributed system. Since the changes are smooth and progressive, the system is robust against tolerances in the DC bus voltage measurement of the different components. In other words, if a small change in the average DC bus voltage does not produce the expected response, the average DC bus voltage is changed even more until the desired response is achieved.

It is also clear that power function change as function of the average Dc bus voltage for elements except the MAIN ELEMENT can be not only power functions but can also use other variables such as current, fuel injection, etc. Furthermore, this function does not necessarily have to follow a linear relationship with voltage. Instead if may include other linear or non-linear terms depending on the specific properties of each distributed resource. For example in a system combining solar with wind and/or Fuel Cells in a DC distribution system, it may be preferable that the operation of the fuel cell is maintained close to maximum power in order to maximize the efficiency and lifetime of the generator while the solar and wind can be ramped without penalty. In that case, the fuel cell power can be stepped down when the average DC-link voltage reaches a high value while the solar and wind would be ramped when the voltage exceeds the nominal value. In general the average DC-link voltage is variable according to a function preprogrammed in the MAIN ELMENT as in (1), and the power, current, energy, or other adjusted variable from each component in the distribution system is decided based on the average DC-link voltage using a pre established equation as in (2)

Vdc_{Link}=f(F,E,I) (1)

F,E,I=f(Vdc_{Link}) (2)

The limiting functions for the different generators and loads may be determined by cost, performance, or durability decisions and may differ from one generator to another in the same DC distribution system.

The smooth control of the average DC bus voltage and the progressive response of the components connected to the DC bus enable a plug and play type of system where new resources and loads can be programmed with specific response curves and then be added to the bus without the need to reconfigure the element controlling the average DC bus voltage or other sources and loads in the system. In a similar way, resources and loads can be removed without any effect on the rest of the installation.

### BRIEF DESCRIPTION OF THE DRAWINGS

FIG. 3 is an example of a micro-grid using the variable DC-link voltage concept.

### DETAILED DESCRIPTION OF THE PREFERRED EMBODIMENTS

Example of a DC Micro-grid with Variable DC-link Voltage for Energy Management

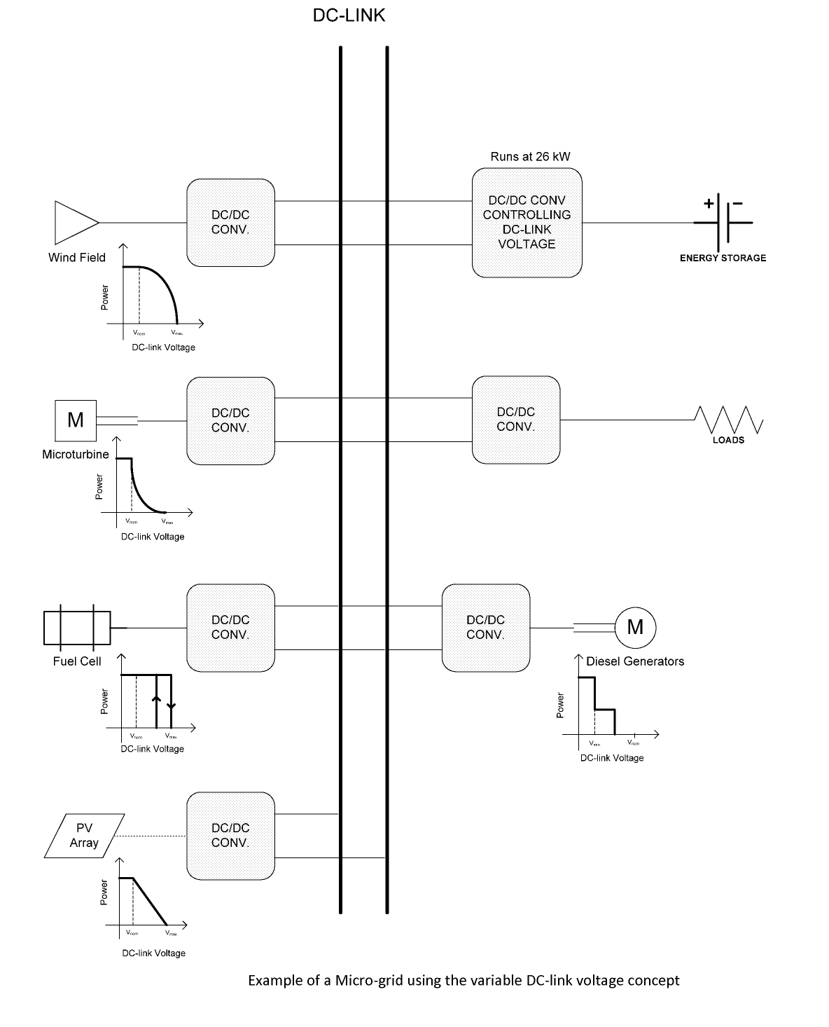

An example of the general concept of the use of variable average DC voltage for optimization of distributed sources and loads is shown in FIG. 3. Here a DC micro-grid with alternative and conventional power generators and loads in a common DC-link, operate in unison. An energy storage resource is used to instantaneously balance the generation with the load and maintaining the DC-link voltage at the desired level. A controller that may or may not be part of the energy storage unit, is responsible for keeping the state of charge for the energy storage within limits. The energy storage controller could adjust the DC-link voltage to get more or less energy from the distributed resources and the distributed resources could have different power vs average DC-link voltage (PvsV) functions depending on the cost and benefit of operating each of these distributed resources as is indicated in FIG. 3. The PvsV equations can automatically change during the day or during different seasons during the year to minimize the operating cost of the micro-grid.

Although the example in FIG. 3 shows the loads as uncontrolled, some loads with lower criticality could also be programmed with PvsV equations or “shaved” based on the average DC-link voltage so that they shut down partially or totally if there is low generation in the micro-grid and the energy storage is reaching low levels of charge. This will give full flexibility to controller to adjust the energy production and energy consumption within the micro-grid without the need for communication so that it can ensure the stability and continuous operation of the micro-grid. As in the case of the generators, the loads equation as function of the voltage could change depending on the time, season or other external characteristics.

What is claimed is:

1. A method to interconnect several conventional or alternative power generators, loads, and/or energy storage elements physically separated from each other in a DC distribution system, which method comprises:
providing a common DC bus to interconnect all the elements in the DC distributed System using power converters;
using a first group of one or more of the elements (MAIN ELEMENT) to automatically maintain the voltage of the DC link following a set point to provide for said load matching;
intentionally changing the average DC link voltage (set point) maintained by the MAIN ELEMENT in order to indicate all the other elements connected to the DC bus how they need to modify their power generation or consumption.

2. A method according to claim 1, wherein the DC link voltage set point for MAIN ELEMENT is intentionally changed in response to performance requirements that constitutes a SECONDARY FUNCTION to be satisfied.

3. A method according to claim 2, wherein the SECONDARY FUNCTION is based on either a set of requirements for energy or battery management, or a set of AC grid support needs, or a set of average power generation/consumption constrains.

4. A method according to claim 3, wherein the MAIN ELEMENT has fixed logic associated therewith, such that the function used to obtain the DC link voltage set point can be a linear or non-linear function.

5. A method according to claim 4, wherein the function used to obtain the DC link voltage set point maintained by the MAIN ELEMENT can be changed hourly, daily, or seasonally or can be changed depending on cost fluctuation for the different elements to optimize a performance factor in any of the elements or in the total system.

6. A method according to claim 1, wherein the amount of power exchanged between the DC link and all the elements connected to the bus except the MAIN ELEMENT varies automatically in response to the average voltage of the DC link.

7. A method according to claim 6, wherein each of the elements connected to the bus except the MAIN ELEMENT has fixed logic associated such that the function used to obtain the power variance in response to the average DC link voltage associated with said each element can be a linear or non-linear function.

8. A method according to claim 7, wherein the function used to obtain the power variance in response to the average DC link voltage associated with each element connected to the bus except the MAIN ELEMENT can be changed hourly, daily, or seasonally or can be changed depending on cost fluctuation for the different elements to optimize a performance factor in any of the elements or in the total system.

9. The distribution system from claim 1 where the MAIN ELEMENT is one or more energy storage devices connected through power converters to the DC bus.

10. The distribution system from claim 1 where the MAIN ELEMENT is one or more grid connected inverters connected through power converters to the DC bus.

11. The distribution system from claim 1 that may run connected to an utility grid or independent from any utility grid.

12. A central controller or power converter with controlling ability responsible from intentionally setting and maintaining the DC-link voltage of the distribution system and acting as the MAIN ELEMENT in claim 1.

13. The DC distributed system from claim 1 when used for a DC microgrid with or without energy storage and with or without connection to the grid.
